(19) United States
(12) Patent Application Publication
(10) Pub. No.: US 2026/0039100 A1
(43) Pub. Date: Feb. 5, 2026

(54) METHOD FOR CONTROLLING AN ELECTRICAL SYSTEM OF A HYBRID AIRCRAFT, CONTROL DEVICE, AND HYBRID AIRCRAFT

(71) Applicant: AIRBUS OPERATIONS SAS, Toulouse (FR)

(72) Inventors: Pierre DASTE, Toulouse (FR); Mohamed Khaled KAHALERRAS, Toulouse (FR); Anne-Marie LIENHARDT, Toulouse (FR)

(73) Assignee: AIRBUS OPERATIONS SAS, Toulouse (FR)

(21) Appl. No.: 19/277,153

(22) Filed: Jul. 22, 2025

(30) Foreign Application Priority Data
Jul. 31, 2024 (FR) 2408468

(51) Int. Cl. H02G 5/02; B64D 47/00

(52) U.S. Cl. CPC H02G 5/02; B64D 47/00; B64D 2221/00

(57) ABSTRACT

A method for controlling an electrical system of a hybrid aircraft, the electrical system includes at least two busbars configured to transfer electrical energy between a plurality of subsystems of said aircraft and comprising at least one centralised regulation control device, the method includes the regulation of a voltage level performed by the controller from one or more variable regulation points determined from among a plurality of predefined regulation points and each located in either one of the busbars, as a function of the nature of the transfers of electrical power that are to be performed.

### TECHNICAL FIELD

The present invention relates to a method for controlling electrical regulation in an electrical system of an aircraft, hereafter called hybrid aircraft, with an aircraft architecture of the hybrid electric propulsion type comprising one or more energy sources and one or more power converters respectively associated with these sources. More specifically, the invention relates to controlling electrical reference points for regulating the operation of voltage converters operating at different points in a hybrid aircraft.

### PRIOR ART

Hybrid aircraft conventionally use thermal engines, for example, turbojet engines or even unducted fan engines, as well as electric motors that may or may not be coupled to the thermal engines. Thermal engines, the primary function of which is to propel the aircraft, conventionally include generators capable of generating electrical energy from the rotation of at least one mechanical shaft. In addition, batteries assist thermal propulsion by supplying surplus energy to one or more thermal engines for operations requiring high power, such as start-up, for example, or such as assistance with the acceleration of the thermal engine. These batteries can be recharged during certain flight phases. The diversity of the configurations or the reconfigurations that are required, given these new hybrid architectures, results in a diversity in the possible combinations of electrical power transfer flows in the electrical systems of such a hybrid aircraft. In addition, the power transfers are likely to occur at points that are far apart from each other. For example, power may need to be transferred from one engine shaft to another when assisting the engine, via a busbar located in a nacelle. In another case, such as engine assistance, power transfer using a battery may require energy to be transferred via a busbar in a fuselage located at a significant distance from a nacelle. It therefore becomes difficult for voltage or current regulation to be performed, if applicable, in the various electrical circuits of an electrical system of a hybrid aircraft, while maintaining the electrical stability of the system, and the situation can be improved.

### DISCLOSURE OF THE INVENTION

An aim of the present invention is to simultaneously and dynamically control the regulation of a plurality of two-way electrical sources coupled to one or more batteries in an aircraft architecture of the hybrid electric propulsion type in which one or more power sources (engine or generator) are used reversibly (in both directions).

To this end, a method is proposed for controlling an electrical system of a hybrid aircraft, the electrical system comprising at least two busbars configured to transfer electrical energy within or between a plurality of subsystems of said electrical system of the aircraft, said method comprising at least one regulation of a voltage level from a variable regulation reference point, determined under the control of a centralised regulation control device, from among a plurality of predefined regulation reference points and each located in either one of said busbars, as a function of the operating conditions of the hybrid aircraft.

According to one embodiment, the regulation of a voltage level is sequentially performed from two predefined regulation points, one after the other, one of which is defined in a first busbar, included in an engine nacelle of the aircraft, and the other one of which is defined in a second busbar, included in the fuselage of the aircraft.

According to one embodiment, the sequentially performed regulation of a voltage level comprises the steps of:
obtaining information representing said operating conditions of the aircraft;
determining a regulation reference point to be used based on said obtained information; then
configuring one or more power converters so as to regulate voltage or current from said determined regulation point.

According to one embodiment, the determination of a regulation point to be used based on said obtained information comprises reading a table of information associating a plurality of combinations of operating conditions of the aircraft, on the one hand, and at least one regulation reference point to be used for each of said combinations, on the other hand, with said table being stored in an information memory of said hybrid aircraft.

A further aim of the invention is an electrical system of a hybrid aircraft, the electrical system comprising at least two busbars configured to transfer electrical energy within or between a plurality of subsystems of the electrical system of the aircraft, the electrical system comprising electronic circuitry configured to regulate a voltage level under the control of a centralised regulation control device, from a variable regulation point determined from among a plurality of predefined regulation reference points and each located in either one of said busbars, as a function of the operating conditions of the hybrid aircraft.

According to one embodiment, the system is configured to allow the regulation of a voltage level to be sequentially performed from two predefined regulation points, one after the other, one of which is defined in a first busbar, included in an engine nacelle of the aircraft, and the other one of which is defined in a second busbar, included in the fuselage of the aircraft.

According to one embodiment, the electrical system of an aircraft further comprises electronic circuitry that is configured to:
obtain information representing said operating conditions of the aircraft;
determine a regulation reference point to be used based on said obtained information; then
configure one or more power converters so as to regulate voltage or current from said determined regulation point.

According to one embodiment, the electrical system of an aircraft further comprises electronic circuitry that is configured to determine a regulation reference point to be used based on the obtained information by reading a table of information associating a plurality of combinations of operating conditions of the aircraft, on the one hand, and at least one regulation reference point to be used for each of said combinations, on the other hand, with said table being stored in an information memory of said hybrid aircraft.

A further aim of the invention is an aircraft comprising at least one centralised regulation control device as described above operating in an electrical system of an aircraft.

A further aim of the invention is a computer program product comprising program code instructions for executing the steps of a method as described above when this program is executed by a processor of a centralised regulation control device in an electrical system of a hybrid aircraft, as well as a storage medium comprising such a computer program product.

### BRIEF DESCRIPTION OF THE DRAWINGS

FIG. 1 schematically illustrates an electrical circuit of a hybrid aircraft according to the prior art;

FIG. 2 schematically illustrates an electrical circuit of a hybrid aircraft according to one embodiment of the invention;

FIG. 3 is a flowchart illustrating the steps of a regulation method according to one embodiment of the invention;

FIG. 4 illustrates a hybrid aircraft comprising a centralised regulation control device according to one embodiment; and

FIG. 5 schematically illustrates an example of the internal architecture of a centralised regulation control device for an electrical circuit of a hybrid aircraft according to one embodiment.

### DETAILED DISCLOSURE OF EMBODIMENTS

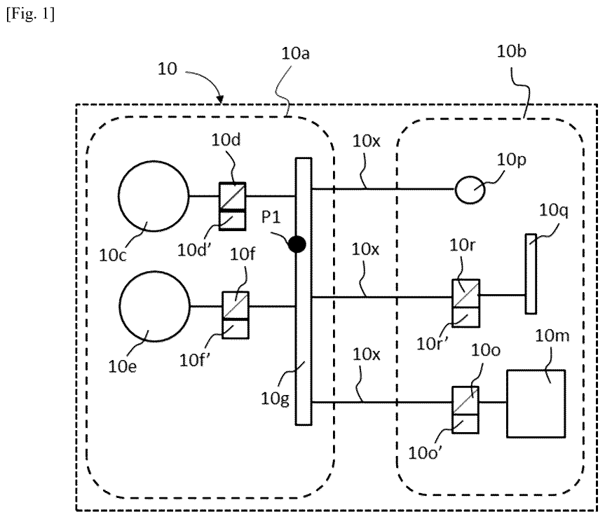

FIG. 1 schematically illustrates an electrical system 10 of a hybrid aircraft according to the prior art comprising at least one electrical subsystem 10a and one electrical subsystem 10b. The electrical subsystem 10a comprises a first energy source 10c and a second energy source 10e respectively connected to a busbar 10g for transferring electrical power via a first power converter 10d and via a second power converter 10f. Each power converter is controlled by a local power converter control device associated therewith. Thus, the power converter 10d is controlled by a local power converter control device 10d′, the power converter 10f is controlled by a local power converter control device 10f. According to the described example of the electrical system, the first energy source 10c is a “high-power” power module configured to operate in conjunction with a high-power assembly of a hybrid aircraft engine, and the second energy source 10e is a “low-power” power module configured to operate in conjunction with a low-power assembly of an engine of the hybrid aircraft. The term “energy source” used herein refers to a machine, an assembly, an element or a module of an aircraft capable of operating in a propulsion engine mode using electrical current or voltage, or of operating in a current or voltage generator mode using mechanical torque, as well as a device for storing electrical current, such as a battery, a supercapacitor or an equivalent component, or even a combination of sources of the same or different types capable of converting a current into the electrical charge level of an electrical charge accumulator, and vice versa. The term “power converter” used herein refers to a machine, an assembly, an element or a module of an aircraft capable of regulating alternating or direct voltage or current from an alternating or direct voltage or current source. According to the described example, the first energy source 10c is capable of generating electrical energy delivered in the form of alternating current from a first rotating mechanical shaft in a generator operating mode, and of also generating rotational torque on this first mechanical shaft from electrical energy in the form of alternating current, in an engine operating mode. Thus, the first electrical energy source 10c is a reversible power transducer. The generator or engine operating configuration of the first energy source depends on the operating conditions or controlled (guided) operating modes of the aircraft on which it is installed. The same applies to the second energy source 10e. Thus, the second energy source 10e is capable of generating electrical energy delivered in the form of alternating current from a second rotating mechanical shaft in a generator operating mode, and of also generating rotational torque on this second mechanical shaft from electrical energy in the form of alternating current, in an engine operating mode, as a function of the operating conditions or controlled operating modes of the aircraft on which it is installed. Thus, the second electrical energy source is also a reversible power transducer.

The electrical energy thus supplied or generated in the first subsystem 10a can be converted into electrical energy in the form of direct current for the purpose of transferring electrical energy via the busbar 10g and/or storing it in one or more batteries of the electrical system 10 of the aircraft. Thus, each of the power converters 10d and 10f is configured to convert electrical energy available in the form of alternating current into electrical energy available in the form of direct current, and vice versa, depending on the operating conditions or the controlled operating modes of the aircraft. These electrical power conversions require the implementation of electrical regulation mechanisms to ensure that the features of the currents and voltages present in the various electrical lines, as well as in the various components and modules of the subsystem 10a of the electrical system 10 of the aircraft, remain within operating value ranges meeting the integrity and safety conditions of the system, and the predefined normal operating conditions. As a result, the electrical power converters 10d and 10f each perform regulation operations using a first electrical regulation reference point P1, used for voltage control, and determined as a point on the electrical line that is the busbar 10g of the electrical subsystem 10a.

The electrical subsystem 10b of the electrical system 10 of the aircraft thus uses the same electrical power transfer busbar 10g that a main battery 10m is connected to via a power converter 100 controlled by a local control device 10′o, and that an electrical energy distribution busbar 10q is also connected to via a fourth power converter 10r controlled by a local control device 10′r associated therewith. The busbar 10q is configured and used to distribute electrical energy to numerous items of equipment on board the aircraft, for example, passenger cabin equipment. In addition, the electrical subsystem 10b comprises means 10p for connecting to an external source of electrical energy that is available in the form of a direct current source. Various electrical equipment and circuits in the aircraft then can be supplied with electrical energy from an external source of electrical energy via the connection means 10p and/or the main battery 10m when the aircraft is parked on the ground. In addition, the main battery 10m can be charged from an external source of electrical power via the connection means 10p. The power converters 10r and 100 perform electrical current or voltage regulations from the electrical reference point P1.

In addition, the electrical subsystems 10a and 10b transfer electrical energy between themselves via at least one electrical connection 10x, for example, when the main battery supplies one or more of the energy sources 10c and 10e configured in engine mode or when one or more of these energy sources supplies the electrical subsystem 10b with electrical energy in a generator operating mode. As already indicated, like the electrical regulation mechanisms implemented in the subsystem 10a, electrical regulation mechanisms are used in the electrical subsystem 10b to perform electrical regulations aimed at ensuring that the features of the currents and voltages present in the various electrical lines, as well as in the various components and modules of the electrical subsystem 10b of the electrical circuit 10 of the aircraft 100, remain within operating value ranges meeting the integrity and safety conditions of the system and the normal predefined operating conditions. To this end, the electrical power converters 10r and 100 each perform regulation operations using the electrical regulation reference point P1, used to control the voltage or the current, and determined as a point on the electrical line that is the busbar 10g of the electrical subsystem 10a. In the specific context of a hybrid aircraft, there may be numerous configurations or operating modes since an energy source can operate in engine mode at one instant and in generator mode at another instant. This multiplicity in the operational combinations of the various energy sources and various power converters is likely to result in a wide variety of combinations of electrical energy transfer flows in the electrical system 10 of the aircraft, which is likely to complicate the electrical regulation operations required at the various locations in the electrical system 10. Indeed, significant electrical energy transfers and long cable lengths between the busbar 10g (for example, in the nacelle) and the components of the subsystem 10b (in the fuselage) can disrupt the electrical regulation mechanisms and operations respectively performed in the electrical subsystems 10a and 10b.

For example, the power converters 10d, 10f, and 10r can be configured to convert power from alternating current to direct current, and vice versa, and the power converter 100 is configured to convert power from direct current to direct current, in both directions. In the embodiment described hereafter, reference is made to a direct type of architecture called “HVDC” (High-Voltage Direct Current). The principle is identical in the case of an architecture called “HVAC” (High-Voltage Alternating Current), i.e., alternating current, in which case the converter then also can be a generator.

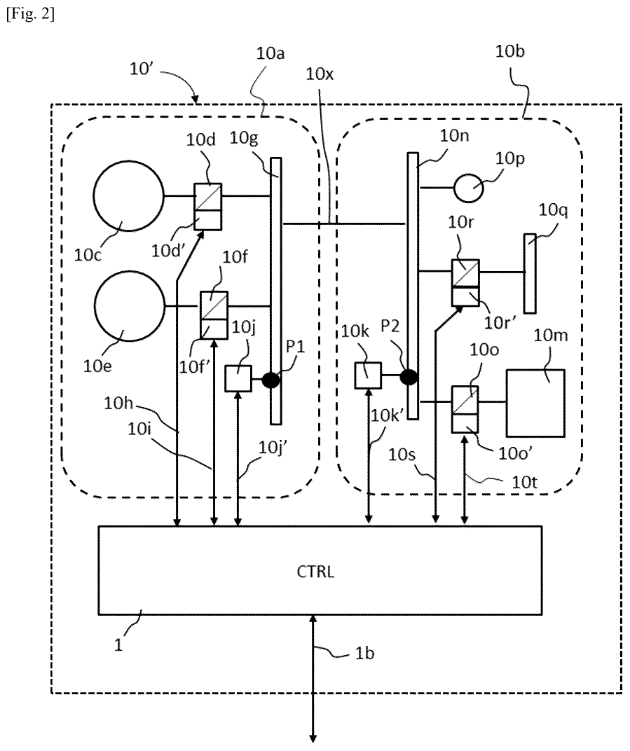

FIG. 2 schematically illustrates an electrical system 10′ of a hybrid aircraft comprising a centralised regulation control device CTRL 1 configured to centrally monitor and control all or some of the local controllers 10d′, 10f′, 10o′, 10r′ of the power converters 10d, 10f, 100, 10r used in the electrical system 10′ of the aircraft. Cleverly and advantageously, and according to one embodiment that is schematically illustrated in FIG. 2, the centralised regulation control device CTRL 1 is connected to each of the controllers 10d′, 10f′, 100′, 10r′ of the power converters 10d, 10f, 100 and 10r, via a dedicated control bus of the electrical system 10 of the hybrid aircraft. Thus, the electrical system 10′ comprises the electrical system 10 according to the prior art, into which the centralised regulation control device CTRL 1 is inserted, as well as means for communicating between this controller CTRL 1 and all or some of the local controllers of the power converters 10d, 10f, 100 and 10r that are used. The electrical system 10′ also comprises at least two busbars 10g and 10n. These elements combined form an electronic circuit that is configured to perform one or more voltage regulations according to the described embodiments. Adding busbars allows them to be arranged as close as possible to the groups of sources located in the same environment or closer to each other. In the illustrated configuration, a first busbar 10g is arranged close to the sources 10c and 10e located in the engine environment and a second busbar 10n is arranged close to the sources 10m and 10q located in the fuselage of the aircraft. The term “close to” means that the busbar is located closer to one energy source or a group of energy sources than to another energy source or another group of energy sources; in this case, the busbar 10g is closer to the energy sources 10c and 10e than to the energy sources 10m and 10q. It should be noted that the term “centralised” in relation to the centralised regulation control device in this case refers to centralised control of regulation in the functional sense of the term: the control device can be physically centralised but also can be distributed over several entities at different locations in the aircraft.

According to the described example, the controller 10d′ of the power converter 10d is configured to operate under the control of the centralised regulation control device CTRL 1, by means of commands or information sent via a communication bus 10h; the controller 10f of the power converter 10f is configured to operate under the control of the centralised regulation control device CTRL 1, by means of commands or information sent via a communication bus 10i; the controller 10′r of the power converter 10r is configured to operate under the control of the centralised regulation control device CTRL 1, by means of commands or information sent via a communication bus 10s, and the controller 100′ of the power converter 100 is configured to operate under the control of the centralised regulation control device CTRL 1, by means of commands or information sent via a communication bus 10t. According to one embodiment, the commands sent by the centralised regulation control device CTRL 1 to the various power converters to which it is connected via the corresponding local controllers comply with a predefined protocol at least including information representing an electrical regulation reference point to be used from among the electrical regulation reference points P1 and P2, in order to regulate the voltage of its output or outputs.

According to one embodiment, the communication buses 10h, 10i, 10s and 10t are two-way and the centralised regulation control device CTRL I can read information that is available in internal information fields of the controllers of the power converter devices, such as, for example, information representing regulation performance capabilities established in relation to the target values of regulation performance capabilities.

The centralised regulation control device CTRL 1 is connected to measurement devices, such as sensors, in order to be able to ultimately determine which of the electrical regulation reference points is to be used from among the regulation reference points P1 and P2 for each of the power converters at a given instant, as a function of the operational configuration or the operating conditions of the aircraft in which it is operating. According to one embodiment illustrated in FIG. 2, measurement devices or modules 10j and 10k are used and configured to respectively take measurements at reference points P1 and P2. The measurement devices or modules 10j and 10k each comprise electronic circuitry and at least one voltage sensor connected to the busbar it is associated with. The device or module 10j is also connected to the centralised regulation controller CTRL 1 via a two-way communication bus 10j′, and the device or module 10k is also connected to the centralised regulation controller CTRL 1 via a two-way communication bus 10k′.

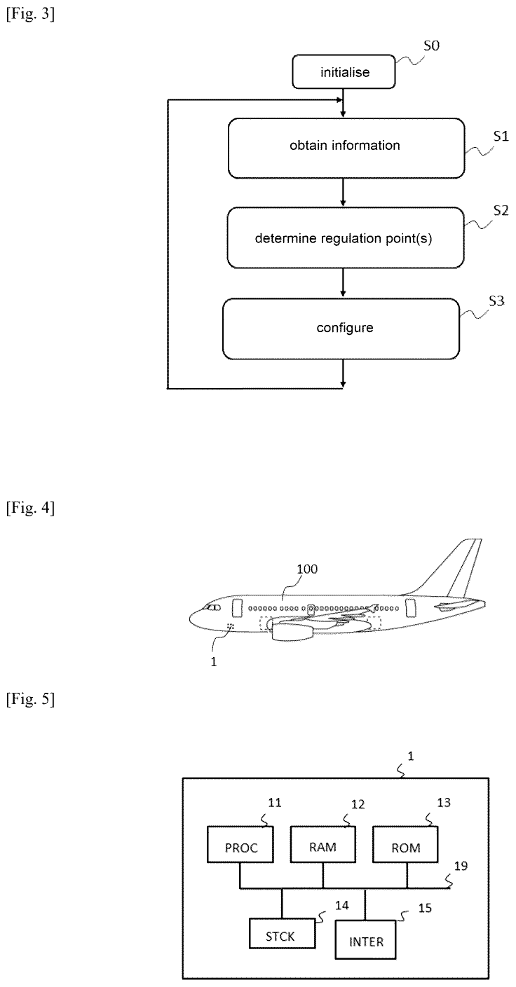

FIG. 3 is a diagram illustrating the steps of an electrical regulation method in an electrical system of an aircraft. According to the described embodiment, the method is performed by the centralised regulation control device CTRL 1 of the hybrid aircraft 100 illustrated with reference to FIG. 4. The method comprises an initial step SO, at the end of which all the circuits and systems of the hybrid aircraft 100 are activated and correctly operational for performing operations while stationary, taxiing or in flight (for example, take-off, climbing, cruising, descending, approaching and landing). During a step S1, the centralised regulation control device CTRL 1 obtains, via a communication bus 1b, information representing the overall configuration of the hybrid aircraft 100, which depends on a flight phase and therefore on the controlled operating conditions of the hybrid aircraft 100. This information is made available to the centralised regulation control device CTRL 1 by one or more avionics modules of the hybrid aircraft 100. This information can be sent to the control device CTRL 1 by one or more avionics modules, or the centralised regulation control device CTRL I may even read it from (in) one or more avionics modules. For example, the hybrid aircraft 100 operating in a climbing phase shortly after take-off is configured to implement main propulsion from thermal engines and to implement secondary propulsion from electric motors powered by one or more main batteries. According to another example, during a descending phase, the thermal engines operate as current generators (energy source) to power the electric motors of the aircraft, allowing flight conditions to be adjusted according to a continuous descending profile. These examples obviously are not limiting. During a step S2, the centralised regulation control device CTRL 1 determines an optimal electrical regulation configuration based on the configuration of the electrical systems of the hybrid aircraft 100, which depends on the piloted flight operations, or, in other words, the piloted operating conditions of the hybrid aircraft 100. Thus, depending on the operating mode of each of the energy sources, operating as a load (engine mode) or as a generator (injecting current into the electrical system of the aircraft), the centralised regulation control device CTRL1 commands, during a step S3, all or some of the power converter controllers by notifying each one of them of the electrical regulation reference point that should be used to implement electrical regulation in terms of current or voltage. According to one embodiment, in order to obtain the desired electrical regulation reference point as a function of the operating conditions, the centralised regulation control device CTRL 1 determines the current configuration based on measurements taken by the measurement devices. According to one embodiment, the centralised regulation control device includes a memory that stores a table that matches electrical regulation reference points to given configurations. Using this table, the centralised regulation control device CTRL 1 determines the regulation reference points to be considered and configures the power converters accordingly via the local power converter controllers. According to a first alternative embodiment, the centralised regulation control device CTRL 1 determines a regulation reference point to be used based on regulation performance measurements taken in the current configuration of the regulation system, notably by means of voltage sensors, and configures one or more power converters accordingly. According to a second alternative embodiment, the centralised regulation control device CTRL 1 determines a regulation reference point to be used based on a reading from the stored table and a regulation performance capabilities level in the current configuration of the regulation system, which level is determined by measurements using voltage level sensors. The method then returns to step S1 in order to be executed iteratively, which advantageously allows dynamic electrical regulation to be performed according to the various steps (or phases) of parking, taxiing and flying that together constitute a flight of the hybrid aircraft 100. Advantageously, it is possible to sequentially regulate a voltage level from a first electrical regulation reference point and then from a second electrical regulation reference point. For example, it may be worthwhile regulating a voltage level by means of a power converter using a reference point on the busbar closest to this power converter. According to one example, when a main power source is the battery, a power converter regulating a voltage downstream of the battery will use the busbar closest to the battery, on the “fuselage side”, whereas at another instant, in the case of a main electrical energy source established on a thermal engine, for example, the voltage regulation will be performed by the associated converter regulating from the reference point of the busbar located on the “nacelle side”, close to this engine. It is possible, for a power converter, for sequential electrical regulation to be performed with point P1 as the electrical reference point, then point P2, then point P2 again, then point P1 again, etc. This example is obviously not limiting.

FIG. 5 is a schematic representation of an example of the internal architecture of the centralised regulation control device CTRL 1 as installed in the hybrid aircraft 100. According to the example of a hardware architecture shown in FIG. 5, the centralised regulation control device CTRL 1 then comprises, connected by a communication bus 19: a processor or CPU (Central Processing Unit) 11; a RAM (Random Access Memory) 12; a ROM (Read Only Memory) 13; a storage unit such as a hard disk (or a storage media reader, such as an SD (Secure Digital) card reader 14; a communication interface module 15 allowing the centralised regulation control device CTRL 1 to communicate with remote devices, such as other systems on board the hybrid aircraft 100, notably via the communication bus 1b.

The processor 11 of the centralised regulation control device CTRL 1 is capable of executing instructions loaded into the RAM 12 from the ROM 13, an external memory (not shown), a storage medium (such as an SD card), or a communication network. When the centralised regulation control device CTRL 1 is powered up, the processor 11 is capable of reading instructions from the RAM 12 and of executing them. These instructions form a computer program causing the processor 11 of the centralised regulation control device CTRL 1 to implement all or part of an electrical regulation method described with reference to FIG. 3 or of described alternative embodiments of this method.

All or part of the method described with reference to FIG. 3 or of its described alternative embodiments can be implemented in software form by executing a set of instructions using a programmable machine, such as a DSP (Digital Signal Processor) or a microcontroller, or can be implemented in hardware form by a dedicated machine or component, for example, an FPGA (Field-Programmable Gate Array) or an ASIC (Application-Specific Integrated Circuit). In general, the centralised regulation control device CTRL 1 comprises electronic circuitry configured to implement the described method with reference to itself. Obviously, the centralised regulation control device CTRL 1 further comprises all the elements usually present in a system comprising a control unit and its peripherals, such as a power supply circuit, a power supply monitoring circuit, one or more clock circuits, a reset circuit, input/output ports, interrupt inputs, bus drivers, with this list not being limiting.

The invention is not limited to only the examples and embodiments described, but more generally to any dynamic allocation of one or more electrical regulation reference points of an electrical system of a hybrid aircraft, under the control of a dedicated and centralised control device, for the purpose of regulating the current or voltage of a power converter circuit according to controlled operating conditions of a hybrid aircraft.

1. A method for controlling an electrical system of a hybrid aircraft, said electrical system comprising at least two busbars configured to transfer electrical energy within or between a plurality of subsystems of said electrical system of the aircraft, said method comprises at least one regulation of a voltage level from a variable regulation reference point, determined under the control of a centralised regulation control device, from among a plurality of predefined regulation reference points and each located in either one of said busbars, as a function of the operating conditions of said hybrid aircraft.

2. The control method according to claim 1, wherein said regulation of a voltage level is sequentially performed from two predefined regulation points, one after the other, one of which is defined in a first busbar, included in an engine nacelle of said aircraft, and the other one of which is defined in a second busbar, included in the fuselage of said aircraft.

3. The control method according to claim 2, wherein said sequentially performed regulation of a voltage level comprises the steps of:
obtaining information representing said operating conditions of the aircraft;
determining a regulation reference point to be used based on said obtained information; then
configuring one or more power converters so as to regulate voltage or current from said determined regulation point.

4. The control method according to claim 3, wherein said determination of a regulation point to be used based on said obtained information comprises reading a table of information associating a plurality of combinations of operating conditions of the aircraft, on the one hand, and at least one regulation reference point to be used for each of said combinations, on the other hand, with said table being stored in an information memory of said hybrid aircraft.

5. A electrical system of a hybrid aircraft, said electrical system comprising at least two busbars configured to transfer electrical energy within or between a plurality of subsystems of said electrical system of the aircraft, said electrical system further comprises electronic circuitry that comprises a centralised regulation control device and that is configured to regulate a voltage level under the control of said centralised regulation control device, from a variable regulation point determined from among a plurality of predefined regulation reference points and each located in either one of said busbars, as a function of the operating conditions of said hybrid aircraft.

6. The electrical system of an aircraft according to claim 5, further comprising electronic circuitry that is configured to allow said regulation of a voltage level to be sequentially performed from two predefined regulation points, one after the other, one of which is defined in a first busbar, included in an engine nacelle of said aircraft, and the other one of which is defined in a second busbar, included in the fuselage of said aircraft.

7. The electrical system of an aircraft according to claim 6, further comprising electronic circuitry that is configured to:
obtain information representing said operating conditions of the aircraft;
determine a regulation reference point to be used based on said obtained information; then
configure one or more power converters so as to regulate voltage or current from said determined regulation point.

8. The electrical system of an aircraft according to claim 7, further comprising electronic circuitry that is configured to determine a regulation reference point to be used based on said obtained information by reading a table of information associating a plurality of combinations of operating conditions of the aircraft, on the one hand, and at least one regulation reference point to be used for each of said combinations, on the other hand, with said table being stored in an information memory of said hybrid aircraft.

9. An aircraft comprising at least one electrical system of an aircraft according to claim 5.

10. (canceled)

11. A non-transitory storage medium comprising a computer program product according to claim 10.
